(19) United States
(12) Patent Application Publication
(10) Pub. No.: US 2023/0153680 A1
(43) Pub. Date: May 18, 2023

(54) RECOMMENDATION GENERATION USING MACHINE LEARNING DATA VALIDATION

(71) Applicant: Oracle International Corporation, Redwood Shores, CA (US)

(72) Inventors: James Charles Rohrkemper, Harbor Springs, MI (US); Kenneth Paul Baclawski, Waltham, MA (US); Dieter Gawlick, Palo Alto, CA (US); Kenny C. Gross, Escondido, CA (US); Guang Chao Wang, San Diego, CA (US); Anna Chystiakova, Sunnyvale, CA (US); Richard Paul Sonderegger, Dorchester, MA (US); Zhen Hua Liu, San Mateo, CA (US)

(73) Assignee: Oracle International Corporation, Redwood Shores, CA (US)

(21) Appl. No.: 17/455,536

(22) Filed: Nov. 18, 2021

(51) Int. Cl. G06N 20/00

(52) U.S. Cl. CPC G06N 20/00

(57) ABSTRACT

Techniques for using machine learning model validated sensor data to generate recommendations for remediating issues in a monitored system are disclosed. A machine learning model is trained to identify correlations among sensors for a monitored system. Upon receiving current sensor data, the machine learning model identifies a subset of the current sensor data that cannot be validated. The system generates estimated values for the sensor data that cannot be validated based on the learned correlations among the sensor values. The system generates the recommendations for remediating the issues in the monitored system based on validated sensor values and the estimated sensor values.

### TECHNICAL FIELD

The present disclosure relates to applying a machine learning model to generated sensor data to generate recommendations to remediate detected issues using a filtered data set of the sensor data. In particular, the present disclosure relates to using machine learning validated sensor values and estimated sensor values to generate recommendations for remediating the issues.

### BACKGROUND

When anomalies arise in a monitored system, the anomalies may be the result of failures in monitored components or failures in sensors that are performing the monitoring. If a fault-remediation system initiates remediation actions based on detected anomalies that are the result of faulty sensors, the remediation actions may fail to address actual faults in the system. In worst-case scenarios, the remediation actions may exacerbate faults and lead to system failures.

An organization may utilize human supervision of computer-based monitoring and remediation systems to verify computer results and perform actions that a computer cannot perform. For example, in one environment, a remediation action may require that a human physically manipulate an object—such as a valve, lever, or switch, or physically observe a component. In another environment, an organization may require human confirmation of computer-generated data. For example, a sensor may indicate a component is at a certain temperature. The organization may require a human-generated temperature measurement to confirm the temperature reading. The human may also determine if any physical flaws are present that may result in a faulty temperature reading by the sensor. In another environment, such as a self-driving vehicle or a computer-monitored data center, both monitoring functions and remediation functions may be capable of being performed by a computer without human intervention. A human may be required in the rare event of a computer fault. However, if a human is not part of a regular observation and remediation process, the human's attention may lapse, and the human may not effectively monitor the computer performance. Accordingly, the organization may require that certain monitoring and remediation tasks be performed by humans, even if a computer may be capable of performing the monitoring and remediation tasks without human intervention.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A and 2B illustrate an example set of operations for generating tasks lists based on machine learning validated data in accordance with one or more embodiments;

FIG. 3 illustrates an example of a set of tasks in accordance with one or more embodiments;

FIG. 4A illustrates an example of training a machine learning model in accordance with one or more embodiments;

FIG. 4B illustrates another example of training a machine learning model in accordance with one or more embodiments;

FIGS. 5A and 5B illustrate an example embodiment of generating tasks lists based on machine learning validated data; and

FIG. 6 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE

3. REMEDIATING SYSTEM ANOMALIES BASED ON MACHINE LEARNING

4. TRAINING MACHINE LEARNING MODELS

5. EXAMPLE EMBODIMENT

6. COMPUTER NETWORKS AND CLOUD NETWORKS

7. MISCELLANEOUS; EXTENSIONS

8. HARDWARE OVERVIEW

### 1. General Overview

One or more embodiments removes a subset of current sensor data, that cannot be validated based on historical sensor data, to generate filtered sensor data. Optionally, the system may generate and add estimated sensor data, in lieu of the removed subset of sensor data, to the filtered sensor data. The system analyzes the filtered sensor data to identify anomalous events, and/or generate a task list to remediate anomalous events.

One or more embodiments train a machine learning model based on historical sensor data to validate a target set of sensor data. A system trains the machine learning model using a set of historical sensor data to learn correlations among the sensors. Upon receiving current sensor data, the machine learning model identifies a subset of sensor data from the sensors that cannot be validated. For example, a sensor may be in a fault state and not transmitting data. Another sensor may be drifting, so that it transmits data, but the data is inaccurate. The system uses learned correlations among the sensors to estimate values for sensors that cannot be validated. The system generates recommendations for remediating faults in the monitored system using a filtered data set that includes the validated sensor data and estimated sensor values for sensor data that could not be validated.

One or more embodiments train a machine learning model based on historical sensor data to generate estimated sensor data. The system trains the machine learning model using a set of historical sensor data to learn correlations among the sensors. Upon receiving current sensor data, the machine learning model predicts values for the sensor values based on the correlations with the values of the remaining sensor values. The machine learning model generates the estimated sensor data based on the predicted values for the sensors.

A sensor-based monitoring system includes one or both of machine-learning-based and human-based sensor validation and fault remediation. A machine learning model is trained to identify correlations among sensor data values of sensors monitoring a system.

The sensor-based monitoring system may generate a task list to remediate one or more detected faults. The system selects task for the task list based on the filtered data set including the validated sensor data and estimated sensor values. The task list may include computer-executed tasks and human-executed tasks. The tasks specify an entity to perform the task, a system component on which the task is to be performed, an action to be performed or executed, any dependency of the task on any other task, and any parameters required to perform the task. The parameters include validated sensor data. For example, the system may select one task to be performed in a sensor generates a first temperature measurement and another task to be performed if the sensor generates a second temperature measurement. The system specifies, in the selected task, the parameter as the generated temperature measurement. If the system cannot validate a parameter for a task, such as if a required sensor value is missing, the system populates the parameter with an estimated sensor value generated by the machine learning model based on the correlation of the missing sensor value and one or more validated sensor values.

In one embodiment, the machine learning model is a deterministic machine learning model. For example, the machine learning model may be a multivariate state estimation technique (MSET) model. The MSET model is trained using a set of sensor values representing a range of non-anomalous values for the sensors. The MSET model identifies correlations among the sensor values. In operation, the MSET model obtains current sensor values, compares the current sensor values with predicted sensor values, and identifies anomalies among the sensor values. In addition, the MSET model determines, based on the identified correlations among the sensor values, when an anomalous sensor value is the result of a faulty sensor or a fault in a monitored component. The MSET model identifies a root cause or situation that is the cause of detected anomalies in the sensor data using a filtered data set that includes non-anomalous sensor values and estimated sensor values. The MSET model further instantiates task parameters for one or more tasks in a task list for remediating a root cause or situation that is the cause of detected anomalies using the filtered data set that includes non-anomalous sensor values and estimated sensor values.

In one or more embodiments, the system receives input to modify tasks in a task list. For example, the system may receive input to: (a) add or remove a task from a task list associated with a particular root cause or situation, (b) add or remove parameters associated with a task in a task list, or (3) modify one or more attributes associated with a task, such as an entity to perform the task.

In one embodiment, the system generates the task list by selecting two or more task templates from among a set of stored task templates. The system queries the set of stored task templates based on the identified root cause or situation underlying one or more detected anomalies in a monitored system. The system populates the query templates with the particular data associated with the identified root cause or situation. For example, a query may return a particular task template associated with an identified situation. The system further identifies a particular entity matching an entity description in the task template, a particular component matching the component description in the task template, and sensor values matching the parameter descriptions in the task template.

The system arranges tasks in a task list according to a set of rules. The set of rules may specify a relative priority of tasks and a dependency of one task on another. For example, a series of three tasks may be required to be performed consecutively and in sequence within a predetermined period of time. According to another example, a task may specify two actions that must be performed simultaneously by two separate entities. The task may specify whether one task may be initiated prior to another and if one task may be completed prior to another. One task in a task list may be given a highest priority, indicating it must be performed prior to any other task. For example, a task list guiding a human through a process for detecting a voltage in a component may begin with a task to separate the component from a power source. A next-highest priority task may also depend on the first task and may direct the human to drain power stored in the component prior to initiating a sequence of tasks for taking measurements on the component.

In one embodiment, the system may determine that one or more sensor values may not be validated and also may not be estimated. Accordingly, the system may generate a human-readable explanation indicating that the particular data is required to generate a task list, but that the data is unavailable. The system may receive input to initiate a related task list. Alternatively, a user may provide the required data manually via a graphical user interface (GUI) to allow the system to generate a task list.

In one embodiment, the system tracks whether tasks are completed. The system may generate a user interface that includes visual elements representing a series of tasks. As the system detects a completed task, the system may modify the visual elements of the GUI to indicate the task has been completed. The system may detect the completion of both computer-executed tasks and human-executed tasks. Alternatively, the system may receive human-generated input to indicate when a human-executed task has been completed. In one or more embodiments, the system may update or modify a task list based on data obtained during execution of one or more tasks. For example, an initial task list may include a series of tasks to replace a system component. The system may detect in an intermediate task, a human-generated measurement indicating a subcomponent has a value outside a safe operating range. The system may generate a notification to stop execution of the initial task list. The system may also generate a new task list to shut down power to the subcomponent. The new task list may replace the initial task list. Alternatively, the new task list may be added to the initial task list.

One or more embodiments described in this Specification and/or recited in the claims may not be included in this General Overview section.

### 2. System Architecture

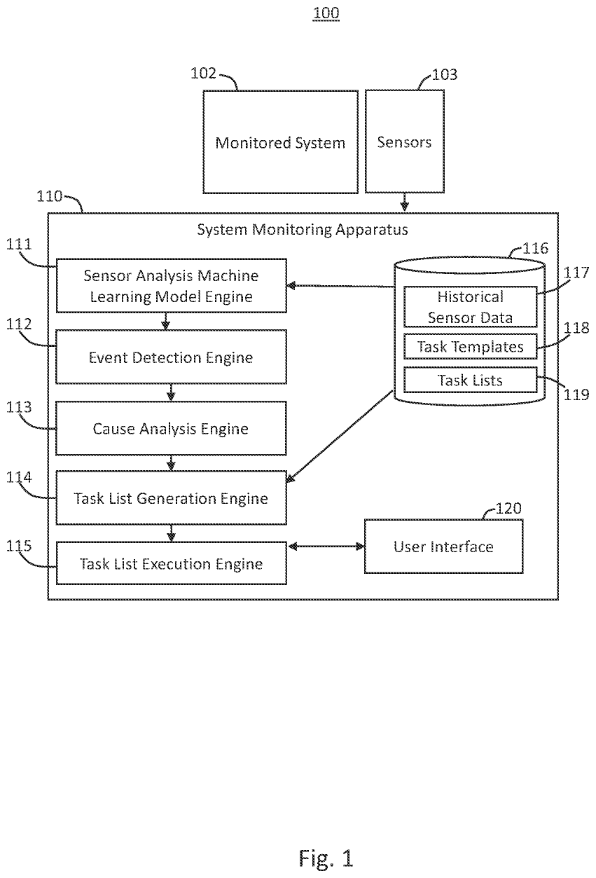

FIG. 1 illustrates a system 100 in accordance with one or more embodiments. As illustrated in FIG. 1, system 100 includes a monitored system 102 and a system monitoring apparatus 110. The monitored system 102 may include any type of system having any number of components. Examples of monitored systems include: vehicles, data centers, computer networks, manufacturing facilities, medical facilities, and power-generation facilities. The monitored system 102 may include any number and type of components, including structural components, motive components, power-generating components, computational components, and data storage components. The components of the monitored system 102 are monitored by sensors 103. The sensors include physical sensors and software that monitors computing elements. For example, a physical motive element may be monitored by a temperature sensor and a piezo-electric sensor. A data processing component may be monitored by a temperature sensor and an application tracking data traffic to and from the data processing component. A medical device may be monitored by position sensors. A vehicle may be monitored by global positioning system (GPS) sensors, an altimeter, and a speedometer. In one or more embodiments, the sensors 103 include tens, hundreds, or thousands of sensors. For example, the numbers and types of sensors may be sufficient that a machine learning model may identify correlations among different sensors monitoring the same system component.

The system monitoring apparatus 110 includes a sensor analysis machine learning model engine 111. The sensor analysis machine learning model engine 111 applies one or more machine learning models to sensor data obtained from sensors 103 monitoring the monitored system 102. The machine learning model may be a stochastic-type machine learning model, such as a neural network. Alternatively, the machine learning model may be a deterministic-type machine learning model, such as a multivariate state estimation technique (MSET) model. A stochastic-type machine learning model applies probabilistic methods to generate predictions. In contrast, deterministic-type machine learning models implement a mathematical structure that, for a given set of input values, will return the same set of output values.

The sensor analysis machine learning engine 111 trains a machine learning model using historical sensor data 117 stored in a data repository 116. The sensor analysis machine learning engine 111 trains the machine learning model to identify correlations among sensor values. In one embodiment, the trained machine learning model receives current sensor data and generates a set of validated sensor values. Validated sensor values may correspond to sensor values that meet predefined criteria. For example, the validated sensor values may fall within a range of predicted values for the sensor. The trained machine learning model may also identify a set of sensor values that cannot be validated. Sensor values that cannot be validated may include values that fall outside a predicted range of values for the particular sensor. Alternatively, sensor values that cannot be validated

In an embodiment in which the machine learning model is a deterministic model, such as an MSET model, the machine learning model may generate, for each sensor value, a delta value representing a difference between the current sensor value and a predicted value for the sensor. The MSET model may indicate an anomaly in a sensor value if (a) the sensor value falls outside a range of non-anomalous values for the particular sensor, or (b) if the sensor value varies from a predicted value by more than a predetermined threshold. For example, an MSET model may identify a correlation between the values of three sensors. The MSET model may determine that, based on the values of two of the sensors, the third sensor should have a particular value. The MSET model may detect an anomaly if the current value for the third sensor varies from the particular value by more than a predefined threshold. In addition, the MSET model may determine that the third sensor has a predefined range of non-anomalous operating values. The MSET model may detect an anomaly if the current sensor value for the third sensor falls outside the predefined range of non-anomalous operating values.

An event detection engine 112 detects whether a triggering event has occurred in the system. A triggering event may be an event detected based on the current values of the sensors 103. Alternatively, the triggering event may be a manually-triggered event intended to initiate a sequence of tasks associated with the monitored system 102. The event detection engine 112 monitors an output from one or both of the machine learning model and the sensors 103 to determine whether anomalies in the sensor values correspond to a sensor-based triggering event in the monitored system 102. For example, one combination of anomalous sensor values may correspond to an overheating-type triggering event. Another combination may correspond to a power failure-type triggering event. Yet another combination may correspond to a data communication failure-type triggering event.

A cause analysis engine 113 analyzes the output from one or both of the machine learning model and the sensors 103 to identify a root cause of the triggering event. For example, if the event detection engine 112 detects sensor data associated with an overheating component, the cause analysis engine 113 may analyze the sensor data and metadata describing the component to identify a failing power adapter in the component as the cause of the overheating event. The cause analysis engine 113 may analyze metadata describing the component to identify the type of component and the specifications of the component, for example. According to another example, if the event detection engine 112 detects a data communication failure event, the cause analysis engine 113 may analyze sensor data from a set of components associated with the communication failure to determine that a router is causing data latency rates that exceed non-anomalous data latency rates. If the cause analysis engine 113 determines that the triggering event was a manually-triggered event, the cause analysis engine 113 may identify a reason associated with the manually-triggered event. For example, a user may interact with the user interface 120 to initiate a power shutdown of a facility based on an emergency that cannot be detected by the sensors 103. The cause analysis engine 113 determines that the root cause of the event is a manually-initiated power shut-down.

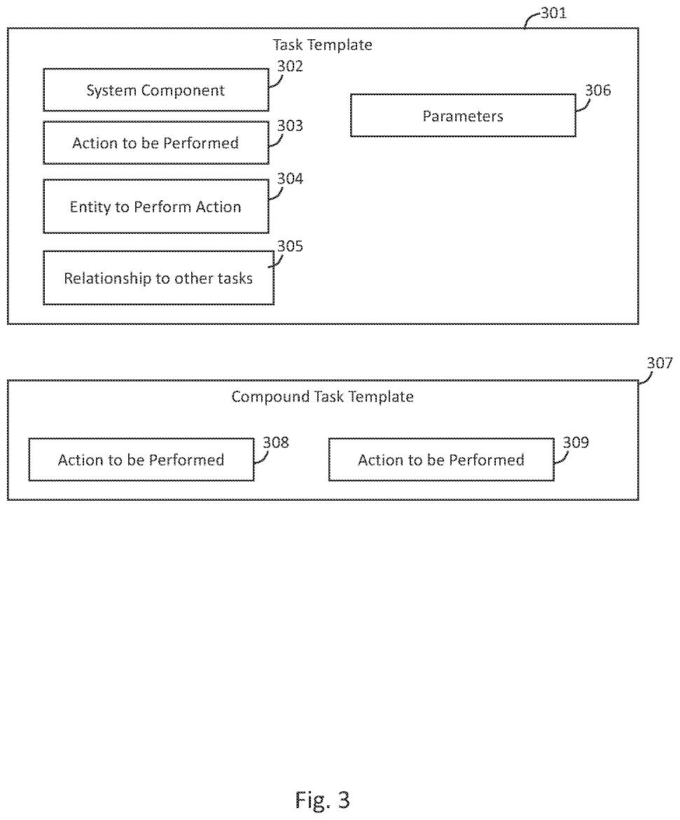

A task list generation engine 114 generates a task list to remediate an identified root cause of a triggering event. The task list generation engine 114 queries a body of task templates 118 stored in the data repository 116 to identify task templates 118 associated with the identified root cause. FIG. 3 illustrates an example of task templates 301 and 307 according to one embodiment. The task list generation engine 114 may select a set of tasks associated with a particular root cause based on one or more of (1) the identified root cause of an event, (2) an output from the sensor analysis machine learning model, and (3) the outputs from the sensors 103. For example, the task list generation engine 114 may generate a set of queries having the following conditions: (a) power levels exceeding a threshold, (b) in a particular power adapter, (c) providing power to particular components, and (d) receiving power from a particular supply. The set of queries may return a corresponding set of tasks designated to be performed in connection with the specified conditions. In one embodiment, the set of tasks is stored as a task list 119. For example, if the same root cause has been encountered previously, a previously-generated set of tasks may be stored as a task list 119. In addition, if a user makes a modification to a set of tasks associated with a particular root cause, the modification may be stored in the task list 119.

The task list generation engine 114 populates the task templates 118 based on particular information associated with the monitored system 102. Referring to FIG. 3, a task 301 includes fields for a system component 302, an action to be performed 303, an entity to perform the action 304, a relationship of the task to other tasks 305, and parameter values 306 corresponding to one or both of measured sensor values and an output from the sensor analysis machine learning model. The task list generation engine 114 populates the system component field 302 with the component in the monitored system 102 that is to be acted upon by an entity. For example, a set of tasks associated with an overheating power adapter may include a task that designates a power supply as a system component 302, flipping a power switch as an action to be performed 303, and a particular operator as the entity to perform the action 304. The task list generation engine 114 may populate the “system component” field 302 with a description of the component to be acted on. For example, the task list generation engine 114 may refer to a specification of a rack including a power supply and power adapter to populate the “system component” field 302 with the data: “power supply M103 located at lower right of server rack.”

The task list generation engine 114 may populate the “entity to perform action” field 304 with the name or role of the particular person responsible for an action. For example, the task list generation engine 114 may access an organization role table to identify “D. Scott” as an engineer responsible for servicing the overheating power adapter. The task list generation engine 114 may populate the “entity to perform action” field 304 with the name “D. Scott” or with the title “engineer.” In one or more embodiments, some tasks in a task list may be performed by human operators and other tasks may be performed by a computer, without human intervention. For example, the task template 301 may identify a computer “COMP-1” as performing a data analysis task subsequent to a user performing a preceding task in the task list.

The task template 301 further identifies a relationship of each task to other tasks 305. For example, the task template 301 may indicate that a current task must be performed immediately after task A, without any intervening tasks. The task template 301 may further specify that the current task must be performed prior to task C, but that one or more tasks may intervene between the current task and task C. The task template 301 may further identify a chain or family of tasks to which a particular template belongs.

As illustrated in FIG. 3, a task template 307 may specify a compound task that may involve two or more actions 308 and 309 to be performed simultaneously. The task template 307 may further specify that the two or more actions 308 and 309 are performed by one or more entities. For example, a compound task template 307 may specify the depression of one button, and while the one button is depressed, depressing a second button. The compound task template 307 may specify the depression of a button on one system component by one operator, and while the one button is depressed, the taking of a measurement by another operator on another system component.

The task template 301 specifies a set of parameters 306 required to perform the task. For example, the task template 301 may specify that, if a temperature sensor value is within a first range, an entity should perform a first action. The task template 301 may further specify that if the temperature sensor value is within a second range, the entity should perform a second action. The action performed may depend on the parameters 306 which correspond to one or both of an output from the sensors 103 and an output from the sensor analysis machine learning model. The parameters 306 may be direct measurements from the sensors 103 and values derived from the measurements. For example, a data system monitor may measure a latency of a data flow associated with a component. The parameter 306 may measure an average packet delay based on the measured latency.

In one embodiment, the task list generation engine 114 determines whether validated sensor data exists to populate parameter fields 306 of a task template 301. For example, validated sensor data may include sensor data that has been determined to fall within a range of non-anomalous values for the sensor. If validated sensor data exists, the task list generation engine 114 populates the parameter fields 306 with the validated sensor data. If the task list generation engine 114 determines that validated sensor data does not exist for a particular parameter, the task list generation engine 114 may determine whether estimated sensor data exists for the particular parameter. For example, the sensor analysis machine learning model may estimate sensor values that cannot be validated based on a learned correspondence between the sensor having values that cannot be validated and other sensors. If an estimates sensor value exists for a parameter, the task list generation engine 114 populates a parameter field 306 with the estimated sensor value. If neither a validated sensor value nor an estimated sensor value exists for a parameter associated with a task template, the task list generation engine 114 may generate a human-readable explanation indicating that a task cannot be performed, and the data required to be able to complete the task. In addition, or in the alternative, the task list generation engine 114 may determine whether one or more alternative tasks may be substituted for the task that cannot be performed. For example, the task list generation engine 114 may apply a set of rules specifying that if a task cannot be performed, one or more alternative tasks may be performed to infer the data for the task that cannot be performed. According to one example a task template may require a particular observation of a component by an operator when a particular parameter has a particular value. However, the value of the particular parameter may not be able to be validated or estimated. Accordingly, the task list generation engine 114 may substitute two alternative tasks for the task having the parameter that cannot be validated or estimated. The two alternative tasks may include measurements of related components based on parameters that may be validated or estimated. The value for the parameter that cannot be validated or estimated may be inferred from the two alternative tasks. Alternatively, the alternative tasks may achieve a desired result without inferring a value for a parameter that cannot be validated or estimated.

In one embodiment, human experts and/or operators generate task templates 118. In addition, the task list generation engine 114 may implement a machine learning model to identify existing task templates to associate with an identified root cause. Additionally, or in the alternative, the task list generation engine 114 may include a machine learning model to generate new task templates based on newly-identified root causes. For example, the task-generating machine learning model may be trained with a data set including: (a) root causes of triggering events, and (b) sets of task templates associated with the root causes (including the components, actions, entities, dependencies, and parameters associated with the task templates). Upon receiving a current root cause having particular characteristics—including a particular component and event type, the task-generating machine learning model may generate a new task template associated with the particular component and event type that may specify a task to be performed, a type of entity to perform the task, a relationship of the task to other tasks, and any parameters required to complete the task.

The task list generation engine 114 may arrange the set of retrieved task templates 118 as a list according to: (a) a priority level of a task, and (b) dependencies of tasks on other tasks. In particular, a task that depends on another task to be completed is arranged lower on the task list than a parent task. In addition, if one task does not have a dependency on another, then the system may arrange the tasks according to a designated priority. For example, the system may apply a rule that, unless a dependency exists, a computer-performed task should be given priority over a human-performed task when ordering a task list. In one embodiment, a task list may include parallel lists of tasks. For example, a power shut-down sequence of a vehicle may require an ordered sequence of tasks performed by two different humans. The task list generation engine 114 may represent the separate sequences of tasks to be performed by the two humans as parallel lists of tasks.

A task list execution engine 115 performs, manages, or tracks the performance of tasks in a task list. For example, the task list execution engine 115 may include an application that causes the user interface 120 to generate a graphical user interface (GUI) including a representation of one or more tasks on a task list. The task list execution may directly monitor the system 102 to determine whether a task is performed. For example, the task list execution engine 115 may display an interface element representing a task for an operator to turn off power to a component. The task list execution engine 115 may detect whether power has been turned off. The task list execution engine 115 may change a representation of the interface element to indicate that it has detected the power being turned off. For example, the task list execution engine 115 may gray-out a representation of the task or display a check mark next to a representation of the task. In addition, or in the alternative, the task list execution engine 115 may allow an operator to interact with a representation of the task in the user interface 120 to indicate completion of the task. Upon completion of the task, the task list execution engine 115 may highlight a next task in the task list to be performed. In addition, the task list execution engine 115 may display tasks in the task list to be performed by a computer. The task list execution engine 115 may initiate, without human intervention, execution of computer-performed tasks based on detecting completion of any prerequisite tasks. For example, if a task list includes a human-performed task to obtain a measurement and a subsequent computer-performed task to analyze system performance using the measurement, the task list execution engine 115 may: (a) wait to perform the computer-performed task until an operator has entered a measurement from the prerequisite task, and (b) upon detecting that the operator has entered the measurement, initiating the computer-performed task without human intervention.

The task list execution engine 115 may further provide functionality via the GUI of the user interface 120 to allow an operator to modify one or more tasks. For example, the task list generation engine 114 may generate a task list for flushing a data storage component in a data center. The task list execution engine 115 may display the task list via the GUI of the user interface 120. An operator may determine that the displayed task list includes tasks that would cause a significant interruption to a customer. The operator may modify, using the GUI, one or more tasks to add a condition that the task should not be performed during a period of time known to be a high-usage time for the customer. Alternatively, the operator may modify the task list to include a new task required by a customer. For example, a customer may require that they be notified of any potential disruption. The operator may add a task requiring an operator to send a notification, and receive a permission, to execute the remaining tasks of the task list. According to another example, an organization maintaining the monitored system 102 may have a safety protocol that is required prior to performing a task. The task list execution engine 115 may allow a user to add a new task including a task specified by the safety protocol using the GUI of the user interface 120.

In one embodiment, the task list execution engine 115 determines whether a task list has been completed. If an operator indicates that a task list cannot be completed, the task list execution engine 115 may provide information associated with the task list and any tasks that cannot be completed to the cause analysis engine 113. The cause analysis engine 113 may determine, based on the completed and uncompleted tasks, whether the detected triggering event in the monitored system 102 is associated with a different root cause than the previously-identified root cause. If the cause analysis engine 113 identifies a different root cause associated with the triggering event, the task list generation engine 114 may generate a new task list to be performed, monitored, and tracked by the task list execution engine 115.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

In one or more embodiments, a data repository 116 is any type of storage unit and/or device (e.g., a file system, database, collection of tables, or any other storage mechanism) for storing data. Further, a data repository 116 may include multiple different storage units and/or devices. The multiple different storage units and/or devices may or may not be of the same type or located at the same physical site. Further, a data repository 116 may be implemented or may execute on the same computing system as the system monitoring apparatus 110. Alternatively, or additionally, a data repository 116 may be implemented or executed on a computing system separate from the system monitoring apparatus 110. A data repository 116 may be communicatively coupled to the system monitoring apparatus 110 via a direct connection or via a network.

Information describing historical sensor data, task templates, and task lists may be implemented across any of components within the system 100. However, this information is illustrated within the data repository 116 for purposes of clarity and explanation.

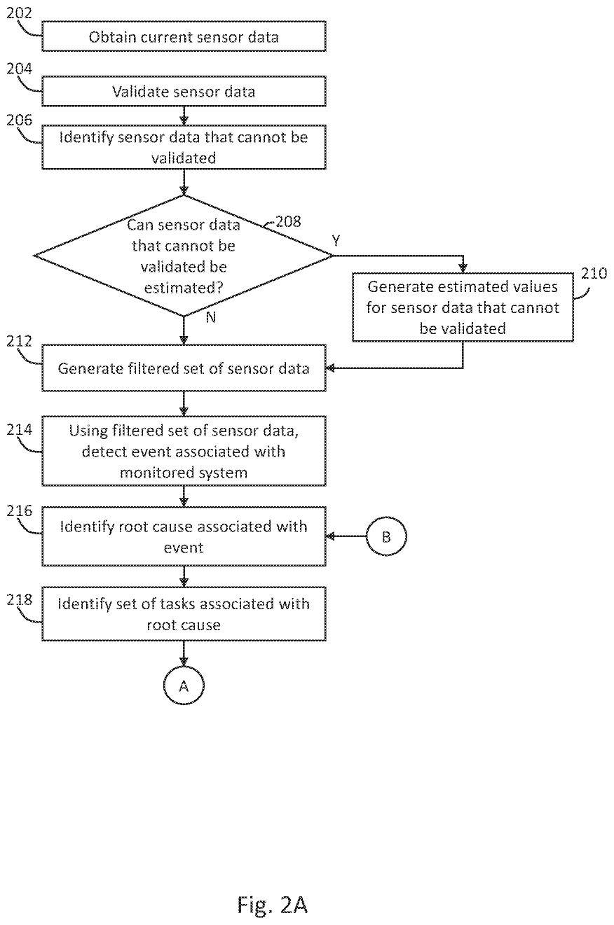

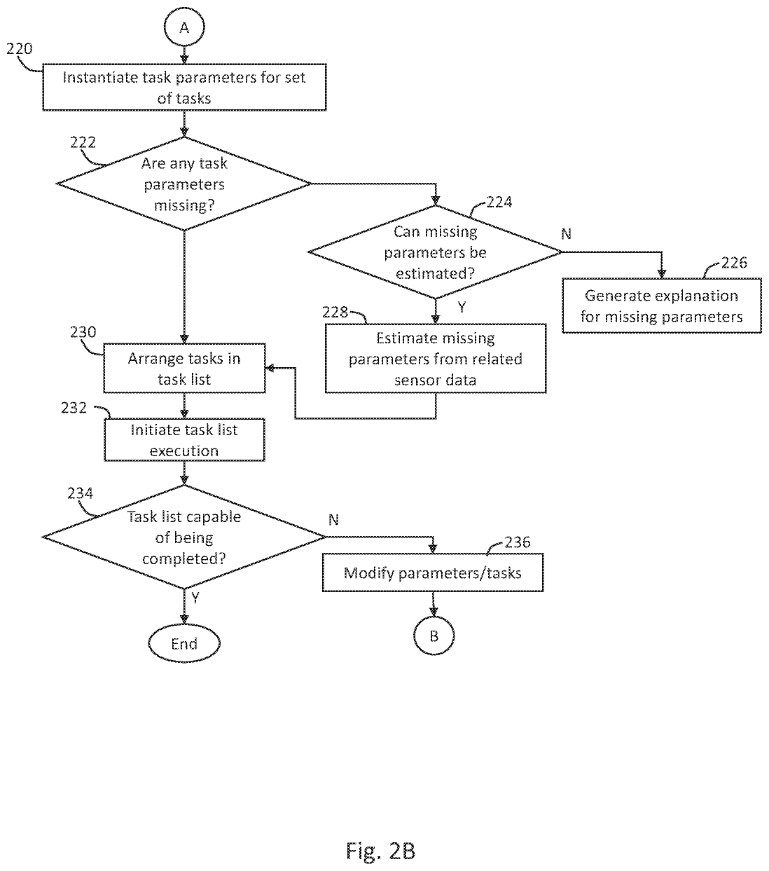

In one or more embodiments, the system monitoring apparatus 110 refers to hardware and/or software configured to perform operations described herein for remediating triggering events detected in a monitored system using a filtered data set including validated sensor data and estimated sensor data. Examples of operations for remediating triggering events detected in a monitored system using a filtered data set including validated sensor data and estimated sensor data are described below with reference to FIGS. 2A and 2B.

In an embodiment, the system monitoring apparatus 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, user interface 120 refers to hardware and/or software configured to facilitate communications between a user and the system monitoring apparatus 110. Interface 120 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 120 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 120 is specified in one or more other languages, such as Java, C, or C++.

### 3. Remediating System Anomalies Based on Machine Learning

FIGS. 2A and 2B illustrate an example set of operations for remediating system anomalies based on a machine learning model by generating and implementing a task list in accordance with one or more embodiments. One or more operations illustrated in FIGS. 2A and 2B may be modified, rearranged, or omitted all together. Accordingly, the particular sequence of operations illustrated in FIGS. 2A and 2B should not be construed as limiting the scope of one or more embodiments.

A system obtains current sensor data (Operation 202). The current sensor data includes measurements from multiple sensors monitoring one or more components of a monitored system. Examples of monitored systems include: vehicles, data centers, computer networks, manufacturing facilities, medical facilities, and power-generation facilities. The monitored system may include any number and type of components, including structural components, motive components, power-generating components, computational components, and data storage components. The sensors include physical sensors, such as thermal sensors, visual sensors, and light sensors. The sensors include software-based sensors, such as applications, clients, or programs, which monitor computing elements in a computer or network of computing devices, network devices, and storage devices.

The system validates the sensor data (Operation 204). Validating the sensor data includes determining that the sensor data meets predetermined criteria. For example, a machine learning model may be trained to identify correlations among sensors. Validating the sensor data may include determining that the current sensor data values are consistent with the learned correlations of the machine learning model. In addition, or in the alternative, validating the sensor data may include determining that a value for a sensor falls within a previously-determined range of non-anomalous values for the sensor.

In one embodiment, the machine learning model is a deterministic machine learning model, such as an MSET model. The MSET model is trained on a set of sensor values that includes the full range of non-anomalous sensor values for a set of sensors. Applying the MSET model to the current sensor data, the system validates the sensor data by (a) determining that each sensor value falls within a previously-learned range of non-anomalous values for the respective sensor, and (b) determining that the sensor data values are consistent with learned correlations with other sensor data values.

The system identifies one or more sensor values that cannot be validated (Operation 206). A sensor value that cannot be validated may include a sensor value that does not match a learned correlation between the sensor and other sensors. For example, a machine learning model may learn that three sensors have output values that track each other. The system may detect that current sensor values for one of the sensors cannot be validated based on detecting that the current sensor values for the sensor is not tracking the output values for the other two sensors.

In an embodiment in which the machine learning model is a deterministic model, such as an MSET model, the machine learning model may generate, for each sensor value, a delta value representing a difference between the current sensor value and a predicted value for the sensor. The MSET model may determine that a sensor value cannot be validated based on determining: (a) the sensor value falls outside a range of non-anomalous values for the particular sensor, (b) the sensor value varies from a predicted value by more than a predetermined threshold. According to one example, the MSET model applies a Sequential Probability Ratio Test (SPRT) algorithm to the sensor value and predicted sensor value to determine whether the sensor value deviates from the predicted value by more than a predetermined threshold. The SPRT algorithm detects anomalous deviations from normal operation by calculating a cumulative sum of the log-likelihood ratio for each successive residual between the measured signals and estimated values, and by comparing the cumulative sum against a threshold at which to determine that a fault is detected.

According to one example, the MSET model may identify a correlation between the values of three sensors. The MSET model may determine that, based on the values of two of the sensors, the third sensor should have a particular value. The MSET model may determine that the third sensor cannot be validated if the current value for the third sensor varies from the particular value by more than a predefined threshold. In addition, the MSET model may determine that the third sensor has a predefined range of non-anomalous operating values. The MSET model may determine that the third sensor cannot be validated if the current sensor value for the third sensor falls outside the predefined range of non-anomalous operating values.

The system determines whether sensor data that cannot be validated can be estimated (Operation 208). In one embodiment, the system trains a machine learning model with a dataset of sensor values to identify correlations among sensors. The system may determine whether a sensor value that cannot be validated may be estimated based on the learned correlation of sensor values by the machine learning model.

Based on determining that a sensor value that cannot be validated may be estimated, the system generates estimated values for any sensor data that cannot be validated but can be estimated (Operation 210). For example, in an embodiment in which a sensor analysis model is an MSET model, the MSET model generates an estimated value for a sensor based on the learned correlation between the sensor and other sensors.

In one embodiment, the system trains and applies one machine learning model to the sensor data to validate the sensor data and another machine learning model to the sensor data to estimate sensor values that cannot be validated. For example, the system may train a machine learning model using a set of historical sensor data to learn correlations among sensor values. The system provides current sensor data to the trained machine learning model to determine whether the correlations between the current sensor values are consistent with the learned correlations among the historical sensor values. The trained machine learning model validates sensor values based on determining the values are consistent with the learned correlations. The machine learning model determines that a subset of the values cannot be validated based on determining that the subset of values are not consistent with the learned correlations with other sensor values. The system trains another machine learning model to learn the correlations among the sensor values in the set of historical sensor data and to predict sensor values based on the other sensor values in the set of historical sensor data. The system provides the current sensor data to the machine learning model. The machine learning model predicts values for the sensor values based on the values of the other sensor values in the current sensor data. The system substitutes the predicted values generated by the second machine learning model for the measured values identified by the first machine learning model as values that cannot be validated.

In an alternative embodiment, the system uses the same machine learning model to both validate the sensor data and estimate sensor data values that cannot be validated. For example, the MSET machine learning model detects when sensor values vary from non-anomalous operating ranges and generate predictions for the sensor values based on learned correlations among the sensor values. The MSET model replaces sensor values that cannot be validated with the predicted sensor values.

Based on the validated sensor data and any estimated sensor data, the system generates a filtered set of sensor data (Operation 212). The system omits from the filtered set of sensor data any sensor data that cannot be validated.

Using the filtered set of sensor data, the system detects an event associated with a monitored system (Operation 214). In one embodiment, the sensor analysis machine learning model trained identifies anomalies in the sensor data. The system may detect a triggering event based on detecting one or more conditions associated with the current sensor data. For example, the system may detect a predefined number of sensor data values that exceed threshold values. The system may detect a particular sensor data value that exceeds a threshold value. In addition, or in the alternative, the system may detect a combination of sensor values that amount to a triggering event, even if one or more of the sensor values is within a non-anomalous sensor value range for the particular sensor. In one embodiment, the system compares estimated values for sensors with current values for the sensors to detect whether the sensor values are anomalous and whether the sensor values amount to a triggering event. In other words, the system may use a combination of the filtered set of sensor data and the current sensor data to detect whether a triggering event has occurred in the monitored system.

The system identifies a root cause of the detected triggering event (Operation 216). The system may analyze the output from one or both of the machine learning model and system-monitoring sensors to identify a root cause of the triggering event. In one embodiment, the system applies a trained cause-analysis machine learning model to the filtered set of sensor data to identify a root cause of the triggering event. For example, the root cause of an overheating component may be the failure of a power regulator on the component. The machine learning model may be trained on a data set that includes (a) historical sensor data, and (b) historically-identified causes for triggering events in the historical data to identify the root cause of the triggering event associated with the current sensor data.

The system identifies a set of tasks associated with the root cause (Operation 218). According to one embodiment, the system generates a set of queries to a database of task templates. The system generates the set of queries based on one or more of (a) the identified root cause, (b) the identified triggering event, and (c) one or both of the current sensor data and the filtered set of sensor data. The task templates include an action to be performed and any dependencies of the task on any other tasks. The task templates further include editable fields that the system populates according to specifications of the monitored system to generate a set of tasks. For example, the system may populate a “component” field with a particular model or description of a system component. The system may populate an “entity to perform the action” field with a name of an operator, a title of the operator, or a name of a computer that is designated to perform an action.

The system instantiates task parameters for the set of tasks (Operation 220). The set of tasks includes parameters that are populated by the system based on the current sensor data. The system may populate the parameters based on the validated sensor data. For example, a task may require a data latency measurement. Another task may require an environmental temperature measurement. The system populates the task parameters based on the measurements in the current sensor data.

The system determines whether the set of tasks includes any missing parameters (Operation 222). For example, the system may determine that a task includes a parameter associated with a current sensor value that cannot be validated. The sensor value that cannot be validated results in a missing task parameter.

The system determines, for any missing parameter, whether the parameter can be estimated (Operation 224). In an embodiment in which the system includes a sensor analysis machine learning model that learns correlations among different sensors, the system may determine whether the sensor analysis machine learning model generates an output value that is an estimate of the sensor value that cannot be validated. In addition, or in the alternative, the system may identify any other sensor values that may be used to estimate a missing task parameter. For example, the system may determine that a first sensor value of a first component may be plugged into a formula to calculate an estimate for a second sensor having a second value that cannot be validated. In yet another embodiment, the system may determine whether any tasks may be substituted for a task having a missing parameter. For example, the system may determine that a data backup-type operation may be initiated by either a first task associated with a first component or by a second task associated with a second component. If a required task parameter of the first task is missing, the system determine that the second task may be substituted for the first task to achieve a desired result.

If the system determines that a missing parameter cannot be estimated, the system generates an explanation for the missing parameter (Operation 226). The explanation may be a human-understandable explanation. The explanation may be selected from among a set of explanation templates. The system may fill in fields of an explanation template to generate the human-understandable explanation. For example, an explanation may indicate that a particular task cannot be completed without a particular measurement, and that sensor data associated with the particular measurement cannot be validated. In one embodiment, the human-understandable explanation is presented to an operator via a GUI. If the task is not a vital task to achieve an objective, the system may give the operator an option to generate a task list without the task. In addition, or in the alternative, the system may provide an interface element to allow the operator to provide the necessary information to complete the task. For example, the user may supply the missing parameter information via the GUI.

If the system determines that the missing parameters can be estimated, the system instantiates the parameters based on estimated parameter values (Operation 228). In the embodiment in which the system includes the sensor analysis machine learning model that learns correlations among different sensors, the system estimates the parameters based on the estimated sensor values for the sensor values that cannot be validated. In an example in which a first sensor value of a first component may be plugged into a formula to calculate an estimate for a second sensor having a second value that cannot be validated, the system may estimate the missing parameter based on the first sensor value in place of the second sensor value. According to an alternative embodiment, the system substitutes one task for another instead of estimating missing parameters. In an example in which two tasks may achieve a desired result, the system may substitute a second task for a first task, where the first task includes a missing parameter.

The system arranges the set of tasks in a task list (Operation 230). The system arranges the set of tasks in a list based on one or both of dependencies between tasks and priority levels of tasks. The system arranges tasks according to dependencies specified in the task templates. For example, a task may specify that it must always be preceded by a particular task. Further the task may specify that it must proceed another particular task. A series of two or more tasks may specify that no intervening task may be performed between the two or more tasks. A task may specify a time period for performing the task. A task may specify any related tasks, such as a task that must be performed simultaneously by another entity. A system may also arrange tasks in a task list according to a priority level of the tasks. The priority level may be set by an operator. According to one example, an operator may identify a particular type of task as having a high priority. Alternatively, the operator may identify tasks associated with a particular component as having a high priority. The system may arrange two tasks that do not have dependencies according to an identified priority.

The system initiates execution of the task list (Operation 232). The system may provide the task list to an operator via a GUI of a user interface, via a print medium, or by any other means. In an embodiment in which the system provides the task list to the operator via the GUI, the system may display the task list and track completion of the task list. The system may update the display of the task list based on detecting the completion of tasks on the task list. During execution of the task list, the system may execute any computer-executed tasks without human intervention based on detecting completion of an immediately preceding task on the task list.

The system determines whether the task list is capable of being completed (Operation 234). For example, a user may generate an input via a GUI that one or more tasks is missing from the task list. A user may generate an input indicating two or more tasks on the task list are redundant. The system may identify one or more tasks that are incapable of being completed. For example, an environment in which a task would need to be performed may not be able to be accessed by a human or a computer. For example, a physical component of a vehicle may not be able to be accessed. Alternatively, a task to validate a set of data may not be able to be accessed due to security protocols.

Based on determining that the list of tasks is not capable of being completed, the system may modify one or both of task parameters and particular tasks associated with a particular root cause (Operation 236). For example, if a user indicates that a task cannot be performed due to the user's inability to access a component to take a measurement, the system may attempt to identify alternative measurements to substitute for the initial measurement or alternative tasks to substitute for the initial task. If a user indicates that a task is missing, the system may generate, based on user input, a new dependency of an existing task template or an entirely new task template. Based on updates to the set of tasks to be performed, the system determines whether the initially-identified root cause is still determined to be the root cause of the triggering event. For example, the system may determine that a user's inability to perform a task indicates that another root cause, different from the initially-identified root cause, may be the actual cause of the triggering event. The system repeats the process of identifying the root cause (Operation 216) and identifying tasks associated with the root cause (Operation 218).

### 4. Training Machine Learning Models

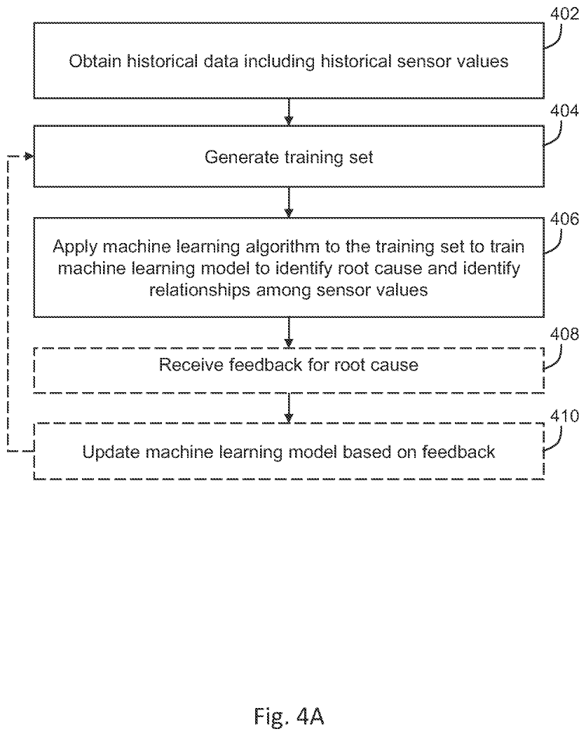

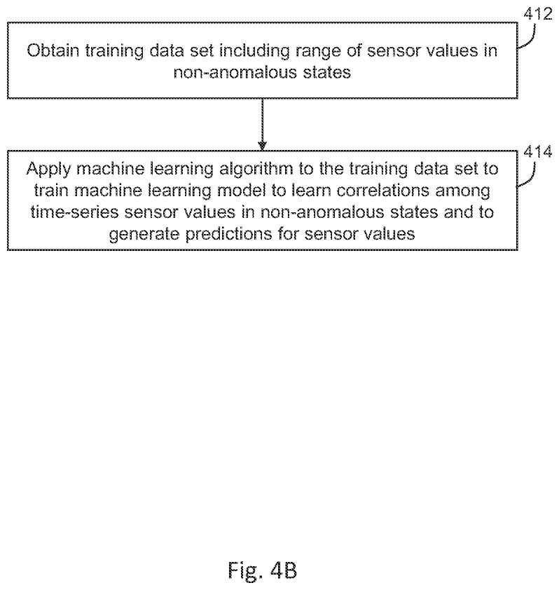

FIGS. 4A and 4B illustrate an example set of operations for training machine learning models to validate sensor data, to identify sensor data that cannot be validated, and to estimate values for sensor data that cannot be validated, in accordance with one or more embodiments. One or more operations illustrated in FIGS. 4A and 4B may be modified, rearranged, or omitted all together. Accordingly, the particular sequence of operations illustrated in FIGS. 4A and 4B should not be construed as limiting the scope of one or more embodiments.

FIG. 4A illustrates an example of a set of operations for training a machine learning model, such as a neural network or support vector machine (SVM), that use a stochastic optimization of the weights, according to one or more embodiments.

A system obtains a set of historical data including historical sensor values and identified root causes associated with particular combinations of sensor values (Operation 402). Examples of sensor values include sensors signals output from physical sensors, such as thermal sensors, light sensors, strain sensors, and positioning sensors, as well as sensors implemented as software executing in a processing device, such as a program to track data capacity, bandwidth, data latency, and dropped data packet rates. Examples of root causes include physical malfunctions of components, circuitry failures, electrical component failures, power outages to components, and misconfiguration of a software component resulting in measurable data transmission or data storage failures.

The system generates a training data set from the set of historical data (Operation 404). The training data set includes sensor values of a set of sensors monitoring a system. The training data set may further include labels of root causes in one or more components of a system being monitored. For example, one data point in the set of training data includes a set of sensor data values and a label identifying one or more causes of anomalous sensor data values in the set of sensor data values. Another data point in the set of training data includes another set of sensor data values and another label identifying one or more causes of anomalous sensor data values.

The system applies a machine learning algorithm to the training data set to train the machine learning model to learn relationships or correlations among sensors and to predict root causes associated with different combinations of sensor values (Operation 406). One or more embodiments include multiple different machine learning models to perform different determinations or predications. For example, the system may train one machine learning model to predict a root cause associated with a particular set of current sensor values. The system may train another machine learning model to identify relationships or correlations among different sensors. The machine learning model may be trained to identify a subset of sensor values in the set of current sensor values that cannot be validated. The machine learning model identifies the subset of sensors that cannot be validated based on determining that the particular values for the subset of sensors are not consistent with the learned relationships among the sensors. The system may train yet another machine learning model to generate predicted or estimated values for sensors. The system trains the machine learning model to learn the relationships or correlations among the sensors. The machine learning model predicts a value for a particular sensor based on the values of the other sensors associated with a set of current sensor values.

In one embodiment, training the machine learning model includes receiving feedback for a root cause identification generated by the machine learning model (Operation 408). For example, the system may display a root cause identification generated by the machine learning model on a GUI. The system may receive one or more inputs to alter the identified root cause. The system updates the machine learning model based on the feedback (Operation 410).

FIG. 4B illustrates an example of a set of operations for training a deterministic-type machine learning (ML) model, such as an MSET model, according to one or more embodiments.

A system obtains a training data set that includes a range of sensor values in non-anomalous states for a set of sensors monitoring a monitored system (Operation 412). The set of training data may include time-series data. The time series data includes a plurality of signals generated by a plurality of sensors monitoring the monitored system. In one embodiment, the output levels of the plurality of signals in the training data include a range of values that are all non-anomalous values. The set of training data may be selected to include sensor data over time in which sensor values for each sensor vary within a range of values that is defined as non-anomalous for the respective sensor.

The system applies a machine learning algorithm to the training data set to train the machine learning model to identify: (a) a range of non-anomalous values for each sensor, and (b) relationships among sensor values for the set of sensors (Operation 414). The deterministic-type ML model is trained using the non-anomalous training data set to model non-anomalous operation of the monitored system. In one embodiment, the deterministic ML model includes an anomalous-signal-prediction model to identify variations of time-series signals from pre-defined operating parameters. The anomalous-signal-prediction model predicts values for the set of sensors based on the learned relationships with the other sensors and identifies when a predicted value for a sensor differs from a current sensor value for the sensor.

One or more operations illustrated in FIG. 4A may be modified, rearranged, or omitted all together. Accordingly, the particular sequence of operations illustrated in FIG. 4A should not be construed as limiting the scope of one or more embodiments.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

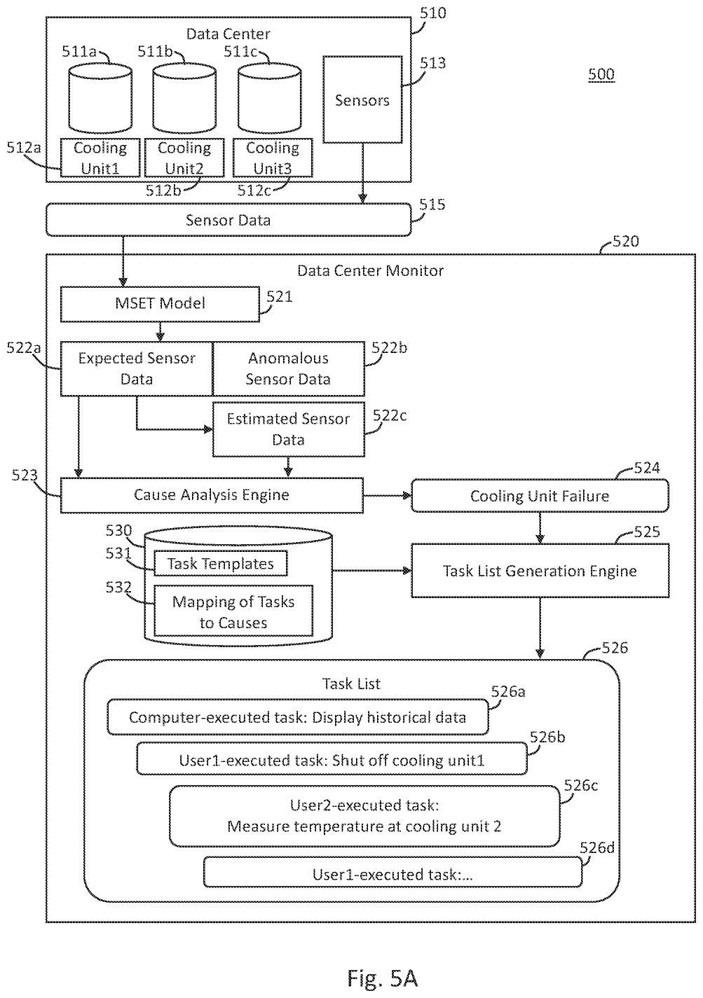

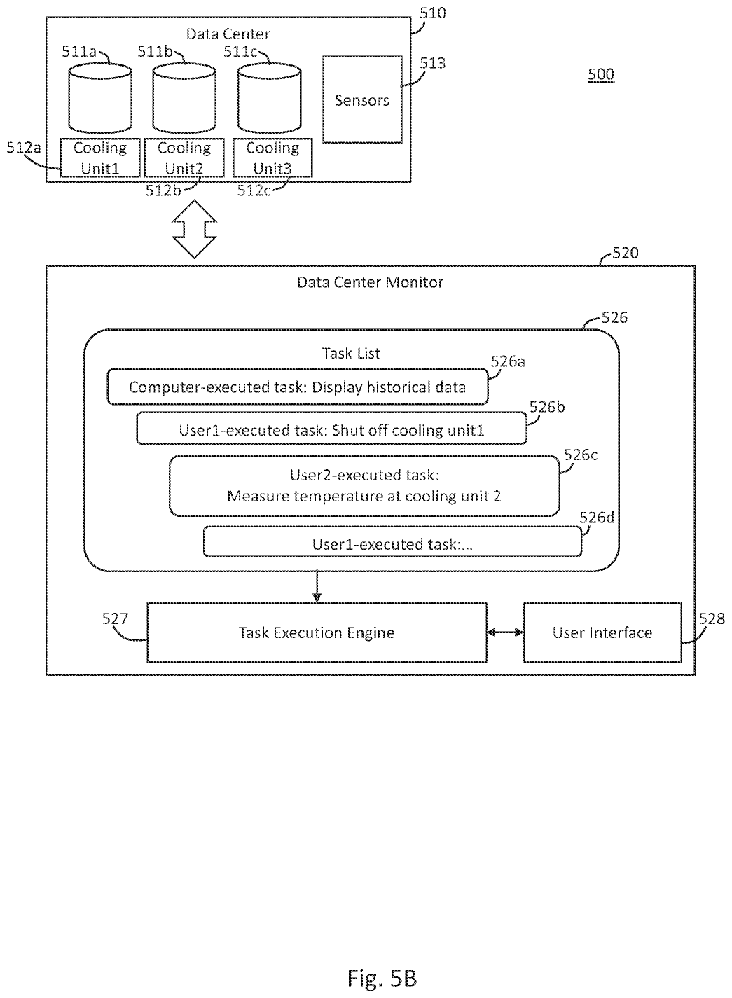

FIGS. 5A and 5B illustrate a system 500 according to an example embodiment. The system 500 includes a data center 510 being monitored by sensors 513. The data center 510 includes computing devices 511a, 511b, and 511c. Cooling units 521a, 512b, and 512c cool the computing devices 511a, 511b, and 511c, respectively.

The sensors 510 provide sensor data to a data center monitor 520. The data center monitor includes an MSET ML model 521 to analyze the sensor data. The MSET ML model 521 has been trained with a training data set of sensor values associated with the sensors 513 to model non-anomalous sensor values associated with non-anomalous operation of the data center 510.

The MSET ML model 521 generates predicted values for the sensors 513. Based on the predicted values, the MSET ML model 521 identifies current sensor values that are expected 522a, such as within a predefined range from the predicted sensor values. In addition, the MSET ML model 521 identifies current senor values that are anomalous 522b, or that (a) have values outside a predefined range of a predicted value, or (b) outside a learned range of non-anomalous values for the sensor. For sensor values that are identified as anomalous based on being outside the predefined range of the predicted value, the MSET ML model 521 generates an estimated sensor data value 522c by replacing the current sensor value with the predicted current sensor value. For example, if a sensor is drifting, such that the output values are over time losing a correlation relationship with a sensed characteristic, the MSET ML model 521 replaces the inaccurate output sensor value resulting from the drift with the predicted sensor value based on the learned correlation between the sensor and other sensors.

A cause analysis engine 523 analyzes the sensor data output from the MSET ML model 521 to identify a root cause associated with a detected triggering event. If the MSET ML model 521 determines, based on learning the correlations among the sensor values, that a particular current sensor value is (a) consistent with learned relationships with other sensors, and (b) at an anomalous level outside a non-anomalous level, the cause analysis engine 523 uses the sensor value. The cause analysis engine 523 determines that the sensor is likely accurately tracking an anomalous state of a monitored component in the data center 510. If the MSET ML model 521 determines, based on learning the correlations among the sensor values, that a particular current sensor value is (a) not consistent with learned relationships with other sensors, the cause analysis engine 523 uses the predicted sensor value for the particular sensor instead of the current sensor value. The cause analysis engine 523 determines that the sensor is likely in a fault state, and the output of the sensor likely does not reflect a state of a monitored component of the data center 510.

In one or more embodiments, the cause analysis engine 523 utilizes the deterministic nature of the MSET ML model to perform a traceback operation to identify a root cause of an event indicated by anomalous signal values. In particular, the MSET ML model implements a mathematical structure that, for a given set of input values, will return the same set of output values. As a result, the MSET ML model is reversible. A given set of input values may be determined based on a respective set of output values. Accordingly, the cause analysis engine 523 performs a traceback operation on the signals output by the MSET model to identify the particular subset of input signals corresponding to detected anomalies.

In the example, embodiment of FIG. 5A, the cause analysis engine 523 identifies a cooling unit failure 524 as a root cause of a detected triggering event. A task list generation engine 525 identifies a set of task templates 531, stored in a data repository 530, associated with the cooling unit failure 524. In the embodiment of FIG. 5A, the task list generation engine 525 refers to a mapping of tasks to causes 532 to identify the particular set of tasks associated with the cooling unit failure 524. The task list generation engine 525 generates a task list 526 representing an ordered sequence of tasks 526a, 526b, 526c, and 526d to be implemented in response to the cooling unit failure 524.

The task list generation engine determines whether the set of tasks 526a-526d includes any missing parameters. For example, the task list generation engine may determine that the task 526b “shut off cooling unit 1” requires a parameter indicating a current temperature of the computing unit 511a and a parameter indicating a temperature of the cooling unit 1 512a. If the system determines that the sensor data for the current temperature of the computing device 511a cannot be validated, the task list generation engine 525 replaces the current sensor data for the temperature of the computing device 511a with predicted sensor data generated by the MSET model 521.

The task list generation engine 525 arranges the set of tasks 526a-526d based on dependencies between tasks and priority levels of tasks. For example, the task 526a is a computer-implemented task without any dependency on another task. The task list generation engine 525 applies a rule that directs it to assign computer-executed tasks a higher priority than human-executed tasks. The task 526c to measure, by a human, a temperature at the cooling unit 2 512b has a defined dependency relationship on task 526b. Accordingly, the task list generation engine 525 arranges the task 526c to be performed subsequent to task 526b.

Referring to FIG. 5B, a task execution engine initiates execution of the task list 526. The task execution engine 527 causes the user interface 528 to display a GUI depicting the task list 526. As a task is performed, the task execution engine 527 may cause the user interface 528 to modify the depiction of the task in the GUI to indicate the task has been completed. For example, the task execution engine 527 may cause the user interface 528 to modify the depiction of the task in the GUI to minimize a completed task, to change a color of a completed task, or to display a check mark next to a completed task. Further, the task execution engine 527 may cause the user interface 528 to modify the depiction of the task in the GUI to display details associated with a current task while minimizing other tasks. The task execution engine 527 may initiate task 526a without human input based on applying a rule to execute computer-executed rules upon completion of a preceding task without waiting for human input.

The task execution engine 527 receives user input via the user interface 528 indicating that a task has been completed. The task execution engine 527 may also detect whether a task has been completed independent of user input via the user interface 528. For example, upon detecting, via the sensors 513, that power has been shut off to the cooling unit 1 512a, the task execution engine 527 may, without human input via the user interface 528, cause the user interface 528 to modify the depiction of the task in the GUI to indicate task 526b has been completed.

In addition, if a user determines that the task list 526 requires modification, such as adding or removing a task, or modifying a task element—such as an entity to perform the task—the user may input a change via GUI displayed in the user interface 528. The task execution engine 527 may modify the task list 526 based on the user input.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

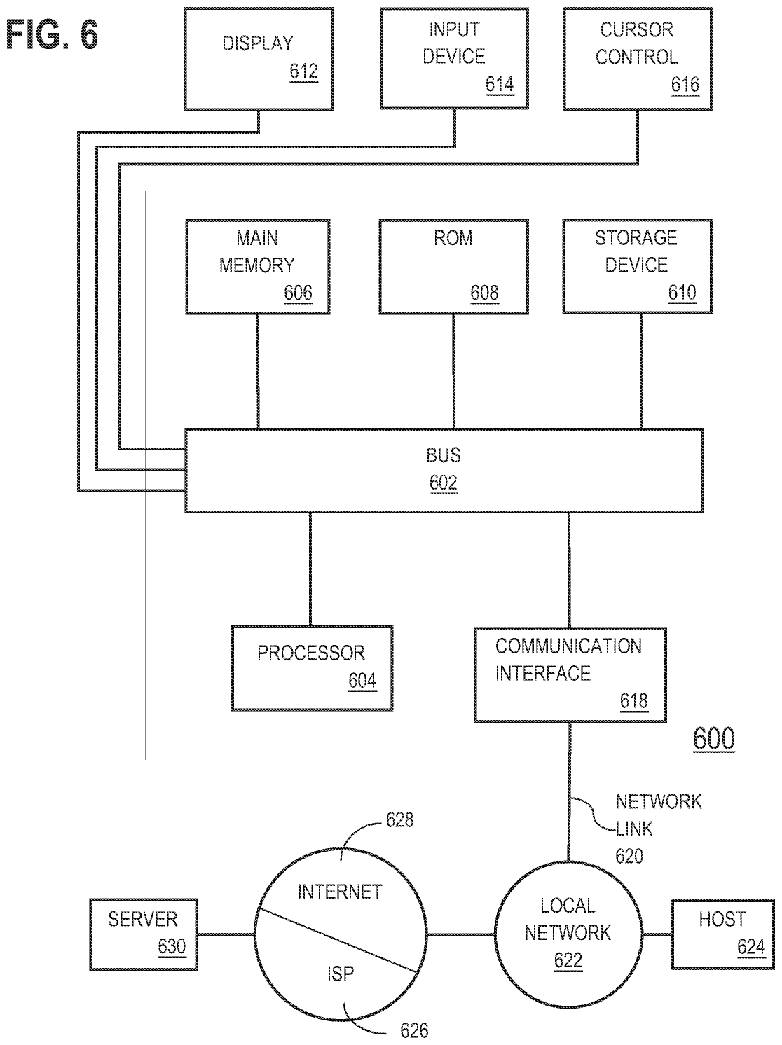

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, cause performance of operations comprising:
training a first machine learning model based on historical sensor data obtained from a plurality of data sources;
applying the first trained machine learning model to current sensor data detected by a plurality of data sources to identify a particular subset of the current sensor data that cannot be validated based on data relationships corresponding to the historical sensor data;
applying a second trained machine learning model to generate estimated sensor data to substitute for the particular subset of the current sensor data that cannot be validated; and
analyzing the current sensor data, with the estimated sensor data substituted for the particular subset of the current sensor data, to generate a task list to remediate an anomalous event.

2. The non-transitory computer readable medium of claim 1, wherein the task list specifies, for a particular task, (a) an entity to perform the particular task, (b) an action to be performed, and (c) a component of a monitored system on which the action is to be performed.

3. The non-transitory computer readable medium of claim 1, wherein the task list comprises an ordered sequence of two or more tasks.

4. The non-transitory computer readable medium of claim 3, wherein at least one first task among the two or more tasks is a task to be performed by a first entity,
wherein at least one second task among the two or more tasks is a task to be performed by a second entity, different from the first entity.

5. The non-transitory computer readable medium of claim 3, wherein the two or more tasks further specify: a dependency of one task, among the two or more tasks, on another task, among the two or more tasks,
wherein at least one task among the two or more tasks includes a dependency upon another task among the two or more tasks, and
wherein the two or more tasks are arranged in a sequence according to the dependency.

6. The non-transitory computer readable medium of claim 3, wherein at least one first task among the two or more tasks is a task to be performed by a human,
wherein at least one second task among the two or more tasks is a task to be performed by a computer without human intervention, and
wherein the instructions further cause performance of operations comprising:
responsive to detecting completion of the at least one second task: generating a human-readable notification associated with the completion of the at least one second task.

7. The non-transitory computer readable medium of claim 1, wherein the operations further comprise:
identifying the anomalous event based on the current sensor data with the estimated sensor data substituted for the particular subset of the current sensor data.

8. The non-transitory computer readable medium of claim 1, wherein the first trained machine learning model and the second trained machine learning model correspond to the same machine learning model.

9. The non-transitory computer readable medium of claim 7, wherein the same machine learning model is a multivariate state estimation technique (MSET) model.

10. The non-transitory computer readable medium of claim 1, wherein the operations further comprise:
obtaining a training data set from the historical sensor data;
training a second machine learning model to identify correlations among the plurality of data sources based on the training data set;
wherein applying the second trained machine learning model to generate estimated sensor data to substitute for the particular subset of the current sensor data that cannot be validated comprises:
identifying, by the second trained machine learning model the correlations among the particular subset of the current sensor data and another subset of the current sensor data that is validated; and
generating the estimated sensor data based on the correlations.

11. The non-transitory computer readable medium of claim 1, wherein the task list to remediate the anomalous event comprises tasks to remediate a root cause of the anomalous event.

12. The non-transitory computer readable medium of claim 11, wherein the operations further comprise:
responsive to receiving an input to modify two or more tasks associated with the root cause, modifying the two or more tasks by performing one or both of:
adding a new task to the two or more tasks; and
removing at least one task from among the two or more tasks; and
re-generating the task list based on the modifying the two or more tasks.

13. The non-transitory computer readable medium of claim 11, wherein generating the task list comprises:
generating at least one query based on the root cause; and
querying a set of stored task templates to identify two or more tasks satisfying query conditions associated with the at least one query.

14. A non-transitory computer readable medium comprising instructions which, when executed by one or more hardware processors, causes performance of operations comprising:
training a machine learning model based on historical sensor data obtained from a plurality of sensors;
applying the trained machine learning model to current sensor data detected by a plurality of sensors to identify a particular subset of the current sensor data that cannot be validated based on data relationships corresponding to the historical sensor data;
filtering out the particular subset of the current sensor data, that cannot be validated, to obtain a filtered set of current sensor data comprising validated sensor data;
performing an analysis on the filtered set of the current sensor data, that does not include the particular subset of the current sensor data, to identify an issue to be remediated; and
generating a recommendation to remediate the issue that was identified based on the filtered set of the current sensor data.

15. The non-transitory computer readable medium of claim 14, wherein the instructions further cause performance of operations comprising:
estimating a second subset of the current sensor data to use in the analysis in place of the particular subset of the current sensor data, the estimating being based on the data relationships corresponding to the historical sensor data,
wherein the analysis is performed further on the estimated second subset of the current sensor data in addition to the filtered set of the current sensor data to identify the issue to be remediated.

16. The non-transitory computer readable medium of claim 15, wherein generating a recommendation to remediate the issue comprises:
generating a task list comprising a plurality of tasks to be performed in sequence to remediate the issue.

17. The non-transitory computer readable medium of claim 16, wherein generating the task list comprises:
identifying a set of parameters necessary to generate the task list, wherein the set of parameters includes at least one value from the filtered set of current sensor data and at least one value from the estimated second subset of the current sensor data.

18. A method, comprising:
training a first machine learning model based on historical sensor data obtained from a plurality of data sources;
applying the first trained machine learning model to current sensor data detected by a plurality of data sources to identify a particular subset of the current sensor data that cannot be validated based on data relationships corresponding to the historical sensor data;
applying a second trained machine learning model to generate estimated sensor data to substitute for the particular subset of the current sensor data that cannot be validated; and
analyzing the current sensor data, with the estimated sensor data substituted for the particular subset of the current sensor data, to generate a task list to remediate an anomalous event.

19. The method of claim 18, wherein the task list specifies, for a particular task, (a) an entity to perform the particular task, (b) an action to be performed, and (c) a component of a monitored system on which the action is to be performed.

20. The method of claim 18, wherein the task list comprises an ordered sequence of two or more tasks.

21. The method of claim 20, wherein at least one first task among the two or more tasks is a task to be performed by a first entity, and
wherein at least one second task among the two or more tasks is a task to be performed by a second entity, different from the first entity.

22. The method of claim 20, wherein the two or more tasks further specify: a dependency of one task, among the two or more tasks, on another task, among the two or more tasks,
wherein at least one task among the two or more tasks includes a dependency upon another task among the two or more tasks, and
wherein the two or more tasks are arranged in the ordered sequence according to the dependency.

23. The method of claim 18, wherein the first machine learning model and the second machine learning model correspond to the same machine learning model, and
wherein the same machine learning model is a multivariate state estimation technique (MSET) model.

24. A system comprising:
one or more processors; and
memory storing instructions that, when executed by the one or more processors, cause the system to perform:
training a first machine learning model based on historical sensor data obtained from a plurality of data sources;
applying the first trained machine learning model to current sensor data detected by a plurality of data sources to identify a particular subset of the current sensor data that cannot be validated based on data relationships corresponding to the historical sensor data;
applying a second trained machine learning model to generate estimated sensor data to substitute for the particular subset of the current sensor data that cannot be validated; and
analyzing the current sensor data, with the estimated sensor data substituted for the particular subset of the current sensor data, to generate a task list to remediate an anomalous event.
